(19) United States
(12) Patent Application Publication
(10) Pub. No.: US 2020/0252802 A1
(43) Pub. Date: Aug. 6, 2020

(54) APPARATUS AND METHOD FOR FRAUD DETECTION

(71) Applicant: PCCW VUCLIP (SINGAPORE) PTE. LTD., Singapore (SG)

(72) Inventors: Kulbhushan Pachauri, Bangalore (IN); Bo Shen, Fremont, CA (US); Srikant Panda, Bangalore (IN)

(21) Appl. No.: 16/269,416

(22) Filed: Feb. 6, 2019

(51) Int. Cl. H04W 12/12; H04W 8/26; H04W 8/18; H04L 29/06; G06N 20/00

(52) U.S. Cl. CPC H04W 12/12; H04W 8/26; G06F 9/546; H04L 63/123; G06N 20/00; H04W 8/18

(57) ABSTRACT

Approaches, techniques, and mechanisms are disclosed for generating subscriptions. According to one embodiment, one or more local features of an input request for service subscription are generated based at least in part on one or more messages originated from a client device that represent the input request. One or more global features of a population of input requests originated from a population of client devices are determined based at least in part on a population of input requests. One or more mapped global features of the input request are generated from the one or more global features via one or more mapping functions. One or more machine learning (ML) based prediction models are applied to the one or more local features and the one or more mapped global features of the input request to compute a fraud score for the input request. The fraud score for the input request is used to determine whether the input request for service subscription is to be accepted.

### TECHNICAL FIELD

Embodiments relate generally to fraud detection, and, more specifically, to techniques for fraud detection using combinations of local and global features related to requests for service subscriptions.

### BACKGROUND

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

Wireless Application Protocol (WAP) billing can be used by mobile users to subscribe to services (e.g., media content services of movies, books, newspapers, games, etc.) from WAP websites with fees charged directly to the mobile users' mobile phone bills.

However, service subscriptions via WAP billing are frequently affected by various type of frauds. Mobile/web applications running on mobile devices may trick users into surreptitious service subscriptions via mobile phone bills without express permission or knowledge of these users through relatively prevalent frauds such as toll frauds. Frauds may be perpetrated by deceiving or leading on users to click on buttons on silently loaded transparent web views not visible or noticeable by the users. Upon the users being led on to click on the buttons, recurring subscriptions to the media content services are initiated with any service subscription confirmations such as SMS messages or emails hijacked to make it harder for the users to detect that the service subscriptions have already been made.

Services affected by frauds may eventually be forced to use different approaches such as online transaction processing (OTP) procedures that are more complex, costly, time consuming than WAP billing to recapture and validate subscription requests that are deemed susceptible to fraudulent manipulations, thereby leading to significant operational inefficiencies and large losses for service providers.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 is an illustrative view of various aspects of an example system in which the techniques described herein may be practiced;

FIG. 2 is an illustrative view of various aspects of an example content service subscription system;

FIG. 3A and FIG. 3B illustrate example block diagrams for training and applying one or more prediction models implemented in a fraud detector;

FIG. 4 illustrates an example process flow; and

FIG. 5 is block diagram of a computer system upon which embodiments of the invention may be implemented.

### DETAILED DESCRIPTION

In the following description, for the purposes of explanation, numerous specific details are set forth in order to provide a thorough understanding of the present invention. It will be apparent, however, that the present invention may be practiced without these specific details. In other instances, well-known structures and devices are shown in block diagram form in order to avoid unnecessarily obscuring the present invention.

Embodiments are described herein according to the following outline:

1.0. General Overview

2.0. Structural Overview
2.1. Content Provider
2.2. Content Collection
2.3. Content Service Subscription System
2.4. Content and Subscription Storage
2.5. Content Distribution
2.6. Subscription Processing
2.7. Content Service Subscription Creation
2.8. Miscellaneous

3.0. Functional Overview
3.1. Training, Testing and/or Using Prediction Models
3.2. Example Process Flows
3.3. Variations

4.0. Example Embodiments

5.0. Implementation Mechanism—Hardware Overview

6.0. Extensions and Alternatives

### 1.0. General Overview

Techniques as described herein can be used to combine various features relating to input requests (e.g., for content service subscriptions, for non-content service subscriptions, etc.) to detect whether any of the input requests is likely to be fraudulent or non-fraudulent. Under these techniques, a multi-prong approach can be used: to adapt to dynamic natures of complex fraudulent acts and situations involving click frauds, WAP frauds, frauds related to digital wallet services (e.g., Pay™, Apple Pay, Alipay, PayPal, etc.), frauds committed through mobile devices and mobile/web apps, static placement frauds, dynamic interactive frauds, etc.; to reduce or avoid charging users for services and/or products which the users do not intend to access and/or consume; to prevent service suspensions because of user complaints about fraudulent charges otherwise would be incurred as a result of undetected frauds; etc.

A two-level fraud detection/protection system as described herein may be used to implement the multi-prong approach. One level in the two-level system may be implemented with a rule-based fraud detection/protection subsystem, whereas the other level in the two-level system may be implemented with a machine learning (ML) based fraud detection/protection subsystem.

Input requests (e.g., training/validation/testing input requests, to-be-predicted input requests, etc.) may be collected and/or aggregated by the two-level system. The input requests include (1) training/validation/testing input requests (e.g., a part of historic data, etc.) to train/validate/test prediction model(s) implemented in the ML-based fraud detection/protection subsystem through supervised learning and (2) to-be-predicted input requests (e.g., real time data, etc.) to be processed by the rule-based fraud detection/protection subsystem and/or the ML-based fraud detection/protection subsystem to determine and/or predict whether any of these to-be-predicted input requests is fraudulent or non-fraudulent.

The rule-based fraud detection/protection subsystem may apply a set of fraud detection rules to check different attributes, parameters, properties, etc., of an incoming input request to decide whether the input request is (e.g., likely to be, etc.) fraudulent or non-fraudulent. Example fraud detection rules may include, but are not necessarily limited to only, those generated from heuristics, expert knowledges, user input, UI interactive states, etc.

The ML-based fraud detection/protection subsystem may implement one or more ML-based prediction models representing an ensemble of one or more different supervised learning models. Example ML-based prediction models as described herein may include, but are not necessarily limited to only, any, some or all of: artificial neural networks (including but not limited to multi-layer neural networks or perceptron, convolutional neural networks, deep neural networks, recurrent neural networks, etc.), models/algorithms based on boosting framework such as AdaBoost, gradient boosting, etc., regression analysis models (including but not limited to linear and/or non-linear regressions, etc.), support vector machines, decision trees, Gaussian process regression models, and so forth.

In a model training phase, a prediction model as described herein may be trained/validated/tested, with training/validation/testing dataset(s) comprising a plurality of training/validation/testing instances generating from input requests (e.g., over the past six months, etc.) for service subscriptions and labels or ground truths prepared for the input requests. The input requests can be used by the ML-based subsystem to calculate global and/or local features on an individual input request basis, across some or all of the input requests, etc. During this model training phase, metrics (e.g., model operational parameters, etc.) can be calculated (or trained/validated/tested) using the training/validation/test datasets for the purpose of finding optimal model operational parameters for the prediction model.

In a model testing/scoring phase, a prediction model as described herein may be used with to-be-predicted input requests in live traffic. The to-be-predicted input requests in the live traffic can be used by the ML-based subsystem to calculate global and/or local features (e.g., same feature types as used in the model training phase, etc.) on an individual input request basis, across some or all of the input requests, etc. The testing/scoring of the prediction model may be performed concurrently and cooperatively with the testing/scoring of other prediction models implemented in the ML-based fraud detection/protection subsystem and/or with the testing/scoring of the rule-based fraud detection/protection subsystem.

In the model testing/scoring phase, the two-level fraud detection/protection system may use the trained prediction models in the ML-based fraud detection/protection subsystem and rules in the rule-based fraud detection/protection subsystem to process the to-be-predicted input requests to identify or assign respective likelihoods/determinations of being fraudulent (e.g., fraud scores, etc.) to the input requests. The to-be-predicted input requests can be collected and aggregated by the two-level fraud detection/protection system, for example in real time or in near real time.

For each such input request, the rule-based fraud detection/protection subsystem may first determine whether the input request is fraudulent. In response to determining that the input request is fraudulent, the rule-based fraud detection/protection subsystem may deny the input request, for example without causing the ML-based fraud detection/protection subsystem to process the to-be-predicted input request.

On the other hand, in response to determining that the input request is non-fraudulent, the rule-based fraud detection/protection subsystem may cause the ML-based fraud detection/protection subsystem to process the to-be-predicted input request. The ML-based subsystem can calculate, extract and/or deduce global and/or local features on an individual input request basis, across some or all of the input requests, etc., from some or all of the to-be-predicted input requests.

An input feature vector with vector components in the form of input features (e.g., local features, features mapped from global features to the input request, etc.) may be generated by the ML-based subsystem from intrinsic and extrinsic information related to the to-be-predicted input request, which, for example, may have not been determined by the rule-based fraud detection/protection system as fraudulent.

The input feature vector may be used as input to the prediction model(s) such as neural networks, regression models, and so forth, that are implemented and trained/validated/tested in the ML-based fraud detection/protection system. Based on the input feature vector of the to-be-predicted input request, the ML-based fraud detection/protection system applies the prediction model(s) to determine or predict whether the input request is fraudulent and non-fraudulent.

Training/validating/testing the prediction model(s) in the ML-based fraud detection/protection subsystem through periodic learning, training the model again if there is significant change in global features or if there is update in WASPA list, etc., can ensure the prediction model(s) to be continuously adapted to volatile and dynamic natures/trends of fraud behaviors and wide ranges/varieties of fraud types that have occurred in the past, are occurring at present, or will occur in future.

Approaches, techniques, and mechanisms are disclosed for generating subscriptions for services. According to one embodiment, one or more local features of an input request for service subscription are generated based at least in part on one or more messages originated from a client device that represent the input request. One or more global features of a population of input requests originated from a population of client devices are determined based at least in part on a population of input requests. One or more mapped global features of the input request are generated from the one or more global features via one or more mapping functions. One or more machine learning (ML) based prediction models are applied to the one or more local features and the one or more mapped global features of the input request to compute a fraud score for the input request. The fraud score for the input request is used to determine whether the input request for service subscription is to be accepted.

In other aspects, the invention encompasses computer apparatuses and computer-readable media configured to carry out the foregoing techniques.

### 2.0. Structural Overview

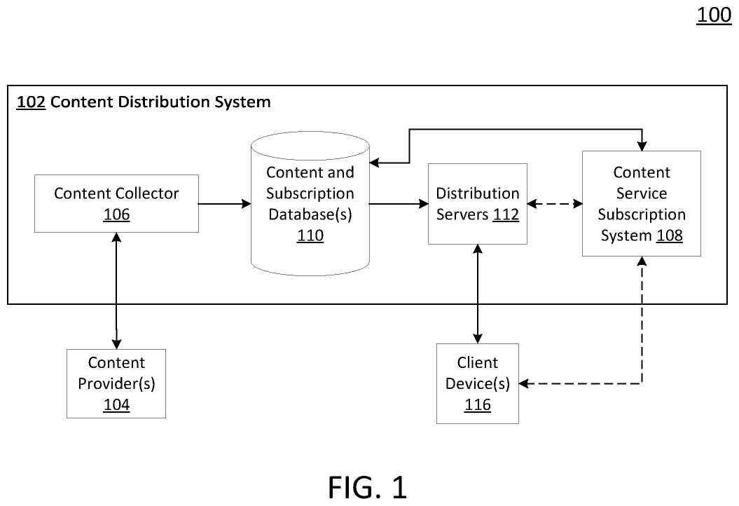

FIG. 1 is an illustrative view of various aspects of an example system 100 in which the techniques described herein may be practiced, according to an embodiment. System 100 comprises one or more computing devices. The one or more computing devices comprise any combination of hardware and software configured to implement the various logical components described herein, including components such as content distribution system 102 and content provider(s) 104. For example, the one or more computing devices may include one or more memories storing instructions for implementing the various components described herein, one or more hardware processors configured to execute the instructions stored in the one or more memories, and various data repositories in the one or more memories for storing data structures utilized and manipulated by the various components.

2.1. Content Provider

System 100 comprises a content distribution system 102, one or more content provider(s) 104 for the purpose of providing source media content items to content distribution system 102, and optionally one or more other systems including but not limited to one or more client devices 116 used to access and/or consume media content items offered for access by content distribution system 102. In various embodiments, there may be a single content providers or multiple content providers interfacing with content distribution system 102 to provide the source media content items to content distribution system 102 for generating the media content items to be accessed and/or consumed by a multitude of client devices such as client devices 116.

Examples of content provider(s) may include, but are not necessarily limited to only, any of: cloud-based media content provider servers, premise-based media content provider servers, professional studio systems, computing devices operated by individual users (e.g., self-media producers, end users, consumers, amateurs, etc.) who upload source media content items for sharing with other individual users such as those operating client devices 116, etc. As used herein, the term “media content item” may refer to a content item comprising one or more of: audio only data, video only data, audiovisual data, any of the foregoing with other multimedia data or information (e.g., still images, close caption, webpages, presentation slides, etc.).

The source media content items can be collected by a content collector 106 of content distribution system 102 in any combination of a wide variety of different methods. For example, none, some, or all of the source media content items may be collected through content feeds implemented by web sites or application interfaces (e.g., RSS, XML, JS ON, etc.) that respond to requests for specific source media content items by streaming or otherwise sending the specific source media content items from content provider(s) 104 to content distribution system 102. In some embodiments, some of the source media content items can be uploaded to content distribution system 102 wirelessly and/or with wired connection from a multitude of end-user computing devices such as PCs, laptops, tablet computers, mobile devices, wearable devices, etc.

2.2. Content Collection

Content distribution system 102 is coupled to content provider(s) 104 via one or more networks, such as the Internet. Via these one or more networks, content collector 106 of content distribution system 102 may support a variety of standards through which content partners or providers may provide content, such as feed-based formats, document files, transfer protocols, or third-party transfer services. Depending on the embodiment, content collector 106 may be configured to continuously scan for and detect new source media content items for content distribution system 102 to distribute, and/or allow for content providers to explicitly instruct the content distribution system 102 to distribute new media content items.

In an embodiment, content collector 106 may be configured to host one or more content provider portals by which content provider(s) 104 may provide source media content items to content distribution system 102. For instance, a content provider as described herein may upload source media content item via a web page or File Transfer Protocol (FTP)-based server of such a content provider portal. In some embodiments, a content provider as described herein may identify specific locations from which content collector 106 may download source media content items.

In an embodiment, content collector 106 may be configured to receive content item components in a variety of formats. The components may be received as, for example, video and/or audio files or streams in any supported format, including without limitation formats such as MPEG, MP4, MKV, WMV, FLV, MP3, WebM, HTML5, DASH, ASTC 3.0, and so forth. There may be different video and/or audio components for different purposes, such as versions having different resolutions or other video formatting characteristics, versions with or without commercials, teasers, expanded or alternate versions, alternate language tracks, and so forth. The components may also include subtitle files in various languages and formats (e.g. SRT or WebVTT), manually authored/curated subscription image files or archives, metadata files in formats such as Excel spreadsheets or XML documents, and so forth.

2.3. Content Service Subscription System

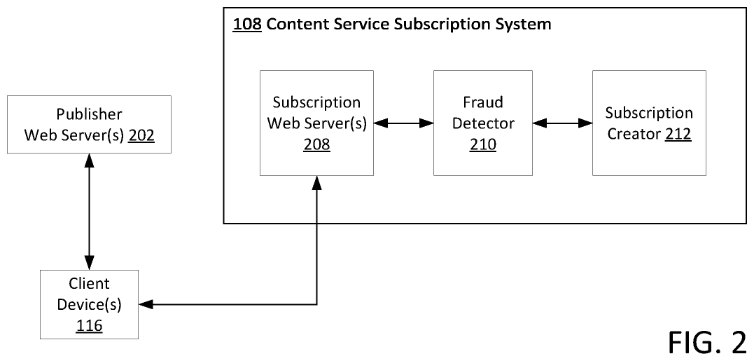

In an embodiment, content distribution system 102 includes a content service subscription system 108 to generate individual subscriptions for accessing and/or consuming some or all of the media content items made available by content distribution systems 102. Content service subscription system 108 may be configured, for instance, to process subscription requests from client devices 116, filter or screen out any of the subscription requests that is determined by a fraud detector (e.g., 210 of FIG. 2, etc.) to be a fraudulent subscription request, generate individual subscriptions based on any of the subscription requests that is determined by the fraud detector to be not a fraudulent subscription request, store the individual subscriptions in content and subscription databases 110, etc.

2.4. Content and Subscription Storage

Some or all of media content items and subscriptions as described herein may be stored in one or more content and subscription database(s) 110. The subscriptions in the database(s) 110 can be made available for access by one or more distribution servers 112 to validate requests for accessing and/or consuming media content made available by the content distribution system 102. The media content items can be made available for access by one or more distribution servers 112 to distribute to client device(s) 116. In some embodiments, content and subscription database(s) 110 may be implemented as a single database. In some embodiments, content and subscription database(s) 110 may be implemented as multiple separate databases.

2.5. Content Distribution

Distribution servers 112 represent one or more content distribution processes to provide access to the media content items made available by content distribution systems 102 to client devices with content service subscriptions. The content distribution processes may access individual subscriptions stored in content and subscription databases 110 as a part of authenticating users or client devices and validating requests for accessing the media content items made available by content distribution systems 102. If authentication and validation of the requests to access the media content items is successfully completed, the content distribution processes operate to provide access to the media content items to client devices 116 with web browsers or mobile/web applications, as a part of web sites, web servers, application servers, backend servers, and so forth. For instance, a web server may generate a navigable hierarchy or other collection of web pages by which the media content items are selectable for consuming (e.g., rendering, displaying, etc.). Upon selection of one or more selectable media content items by a client device with valid subscription credentials, the content distribution processes can operate with the client device to stream or distribute the selectable media content items to the client device.

### 2.6. Subscription Processing

FIG. 2 is an illustrative view of various aspects of an example content service subscription system 108 in which the techniques described herein may be practiced, according to an embodiment. Content service subscription system may be implemented by one or more computing devices. These one or more computing devices comprise any combination of hardware and software configured to implement the various logical components described herein, including components such as subscription web servers 208, a fraud detector 210 and a subscription creator 212.

The content service subscription system 108 comprises one or more computing devices. The one or more computing devices comprise any combination of hardware and software configured to implement the various logical components described herein, including components such as subscription web servers 208, fraud detector 210 and subscription creator 212. For example, the one or more computing devices may include one or more memories storing instructions for implementing the various components described herein, one or more hardware processors configured to execute the instructions stored in the one or more memories, and various data repositories in the one or more memories for storing data structures utilized and manipulated by the various components.

Content service subscription system 108 is coupled to client device(s) 116 and/or publisher web server(s) 202 via one or more networks, such as the Internet. Via these one or more networks, client service subscription system 108 may operate with a number of publisher web server(s) 202 (e.g., web portals, websites, etc.) to generate, receive and process input requests for content service subscriptions originated from client devices 116. Publisher web servers 202 refer to websites that publish subscription invitation messages. Example publisher web servers as described herein may include, but are not necessarily limited to only, any of: internet search engines, social networking websites, e-commerce websites, news websites, messaging websites, internet chat systems, ad servers in different ad networks, and so forth.

In an example, client devices 116 may be visiting, browsing or otherwise accessing web pages as provided by publisher web servers 202. Subscription invitation messages such as commercial messages, advertisements, etc., may be provided on these web pages. These invitation messages may include clickable web links to redirect client devices 116 to send input requests for content service subscriptions to subscription web servers 208.

In another example, client devices 116 may have downloaded and installed web/mobile applications some of which may be downloaded from one or more (e.g., official, iTunes, Android, etc.) app stores, and others of which may be downloaded from other application download websites/sources. Client devices 116 may be running a web/mobile application that interfaces with one or more publisher websites to accept (e.g., pushed, etc.) subscription invitation messages such as commercial messages, advertisements, etc. These invitation messages may include clickable web links to redirect client devices 116 to send input requests for content service subscriptions to subscription web servers 208.

In a non-fraudulent situation, a user operating a client device 116 may respond with volition to such an invitation message by clicking a web link to send or trigger an input request for content service subscription to a subscription web server 208. In response to receiving the input request, subscription web server 208 can send a content service subscription confirmation message as a response to the client device 116. The content service subscription confirmation message may invite the user to click on a confirmation button to confirm the content service subscription. If the user clicks on the confirmation button, a content service confirmation response is sent by the client device 116 to the subscription web server 208. As a result, a (e.g., recurring, non-recurring, etc.) charge may be (e.g., automatically, etc.) incurred for the user.

In a fraudulent situation, without permission or knowledge of a user operating a client device 116, a web link to send or trigger a content service subscription request to a subscription web server 208 may be automatically and surreptitiously clicked (or may be faked to be clicked) by application program code operating in the client device 116. In response to receiving the input request, subscription web server 208 sends a content service subscription confirmation message as a response to the client device 116. The content service subscription confirmation message may be intercepted by the application program code. The confirmation button may be automatically and surreptitiously clicked without the user's permission or knowledge. As a result, a content service subscription confirmation response is sent by the client device 116 to the subscription web server 208 to cause a (e.g., recurring, non-recurring, etc.) fraudulent charge to be (e.g., automatically, etc.) incurred for the user.

Under techniques as described herein, in response to receiving an input request for content service subscription from a client device 116, a subscription web server 208 that receives the input request sends or forwards the input request (or client-device-originated input messages representing the input request) to fraud detector 210. In response to receiving the input request, fraud detector 210 can determine, and then respond to the subscription web server 208, whether the input request is deemed to (or is likely to be) be fraudulent or non-fraudulent.

If the input request is deemed or determined by fraud detector 210 to be non-fraudulent, the subscription web server 208 can send a content service subscription confirmation message as a response to the content service subscription request to the client device 116. The content service subscription confirmation message may invite the user to click on a confirmation button to confirm the requested content service subscription.

Subsequently, in response to receiving a content service subscription confirmation response (purportedly caused by the user clicking on the confirmation button of the content service subscription confirmation message), the subscription web server 208 sends or forwards the content service subscription confirmation response to fraud detector 210. In response to receiving the content service subscription confirmation response, fraud detector 210 can determine, and then respond to the subscription web server 208, whether the content service subscription confirmation response is deemed to (or is likely to) be fraudulent.

If the content service subscription confirmation response is deemed or determined by fraud detector 210 to be non-fraudulent, one or more of subscription web server 208, fraud detector 210 and subscription creator 212 can operate to complete the content service subscription. As a result, the user can access and consume available media content as maintained by content distribution system 102, and a (e.g., recurring, non-recurring, etc.) charge may be (e.g., automatically, etc.) incurred for the user.

In some embodiments, both of an input content service subscription request and a content service subscription confirmation response from a client device in an overall content service subscription transaction (or exchange) are processed by a fraud detector to determine whether either of the content service subscription request and the content service subscription confirmation response is fraudulent. If both of the content service subscription request and the content service subscription confirmation response are non-fraudulent, the requested content service subscription may be processed and created by content service subscription system 108. Otherwise, if either of the content service subscription request and the content service subscription confirmation response is fraudulent, the requested content service subscription may be denied (e.g., silently, by a negative response message, a 404 return code, etc.) by content service subscription system 108.

In some embodiments, a fraud detector may or may not process each individual message (in a set of client-device-originated input messages representing an input request for content subscription), request (e.g., a client-originated request message, etc.), response (e.g., a client-originated response message, etc.), etc., in an overall content service subscription transaction (or exchange). In some embodiments, the fraud detector may process some or all of these messages, requests, responses, etc., in the overall content service subscription transaction (or exchange) collectively as related to an input request for content subscription, in addition to or in place of determining whether each individual message, request, response, etc., in the overall content service subscription transaction (or exchange) is fraudulent. For example, only a selected one of an input content service subscription request (message) and a content service subscription confirmation response (message) from a client device in an overall content service subscription transaction (or exchange) is processed by a fraud detector to determine whether the selected one is fraudulent. If the selected one of the content service subscription request and the content service subscription confirmation response is non-fraudulent, the requested content service subscription may be processed and created by content service subscription system 108. Otherwise, if the selected one of the content service subscription request and the content service subscription confirmation response is fraudulent, the requested content service subscription may be denied (e.g., silently, by a negative response message, a 404 return code, etc.) by content service subscription system 108.

2.7. Content Service Subscription Creation

According to an embodiment, the content service subscription system 108 may comprise a subscription creator 212 to automatically create or generate one or more content service subscriptions in response to determining that one or more input requests are determined to be non-fraudulent.

In an embodiment, subscription creator 212 computes an individual fraudulent score (e.g., a percentile number indicating a likelihood of being fraudulent, etc.) for an individual input request for content service subscription and determines whether the individual fraudulent score is below a minimum fraudulent score threshold (e.g., 20 percentiles, 30 percentiles, 20%, 30%, etc.).

In response to determining that the individual fraudulent score of the input request is below the minimum fraudulent score threshold, subscription creator 212 determines that the input request is not fraudulent (or is not likely to be fraudulent) and proceeds to generate a content service subscription for the input request. As a result, a user of the client device originating the input request can access and consume available media content as maintained for subscribing users by content distribution system 102, and a (e.g., recurring, non-recurring, etc.) charge may be (e.g., automatically, etc.) incurred for the user.

On the other hand, in response to determining that the individual fraudulent score of the input request is not below the minimum fraudulent score threshold, subscription creator 212 determines that the input request is fraudulent (or is likely to be fraudulent) and proceeds to deny creating a content service subscription for the input request. The denial of content service subscription creation may be effectuated and/or accompanied by one or more of: no response (e.g., a silent denial, etc.), with a negative response to a mobile device originating the input request, redirecting or referring the mobile device to a different and more elaborate content service subscription procedure, generating an alarm/message for further investigation/follow-up, etc. As a result of the denial of content service subscription creation, a user of the client device originating the input request cannot access and consume available media content as maintained for subscribing users by content distribution system 102, and a (e.g., recurring, non-recurring, etc.) charge is not (e.g., automatically, etc.) incurred for the user.

2.8. Miscellaneous

System 100 illustrates only one of many possible arrangements of components configured to provide the functionality described herein. Other arrangements may include fewer, additional, or different components, and the division of work between the components may vary depending on the arrangement. For instance, subscription generation techniques as described herein may be practiced in other types of systems that are not necessarily content distribution systems to generate subscriptions for services and/or products.

### 3.0. Functional Overview

In an embodiment, each of the processes/operations described in connection with system, device and/or functional blocks described below may be implemented using one or more computer programs, other software elements, and/or digital logic in any of a general-purpose computer or a special-purpose computer, while performing data retrieval, transformation, and storage operations that involve interacting with and transforming the physical state of memory of the computer.

3.1. Training, Testing and/or Using Prediction Models

A fraud detector as described herein may implement one or more prediction models for predicting or generating fraudulent scores associated with input requests for content service subscriptions. These prediction models may, but are not necessarily limited to only, one or more of: supervised-learning based prediction models, rule-based prediction models, expert-knowledge-based models, and so forth.

By way of illustration but not limitation, training, validating, testing and/or applying a prediction model as described herein may involve two phases: a model training phase and a model testing/scoring phase. In the model training phase, features (local/global) and ground truths may be generated or calculated for example, for some or all input requests that have occurred over a past time period such as the past six months. Data from those input requests over the past time period may be divided into a training dataset, a validation dataset and a test dataset by a set of ratios such as 70:20:10 (e.g., 4-month data as training data, next 1.5 month as validation data, and next 0.5 month as test data, etc.). During this model training phase, metrics (e.g., model operational parameters, etc.) can be calculated, validated and tested using the training/validation/test datasets for the purpose of finding optimal model operational parameters for the prediction model.

In the model testing/scoring phase, live traffic may be used for calculating feature-specific values for the same features (local/global) or the same feature types that were used in the model training phase. The feature-specific values derived from the live traffic are used to predict fraud scores for input requests in the live traffic. If a fraud score for an input request is found beyond a minimum fraud score threshold, then the input request is marked or classified as fraudulent and blocked/rejected for service subscription. In some embodiments, some or all of the input requests in the live traffic that have been scored by a system as described herein may be subjected to ad hoc analyses. Fraud scores for those input requests may be looked up or retrieved based on unique identifiers (e.g., user IDs, MSISDNs, etc.) that are used to identify the input requests. Feature-specific values for those input requests predicted by the system as fraudulent may be reviewed and studied (e.g., at least in part based on human experts/professionals, etc.).

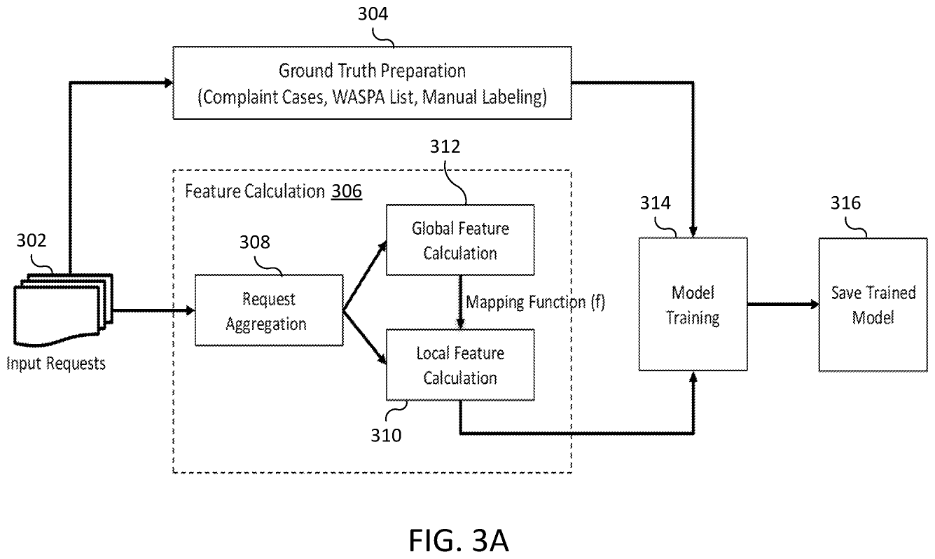

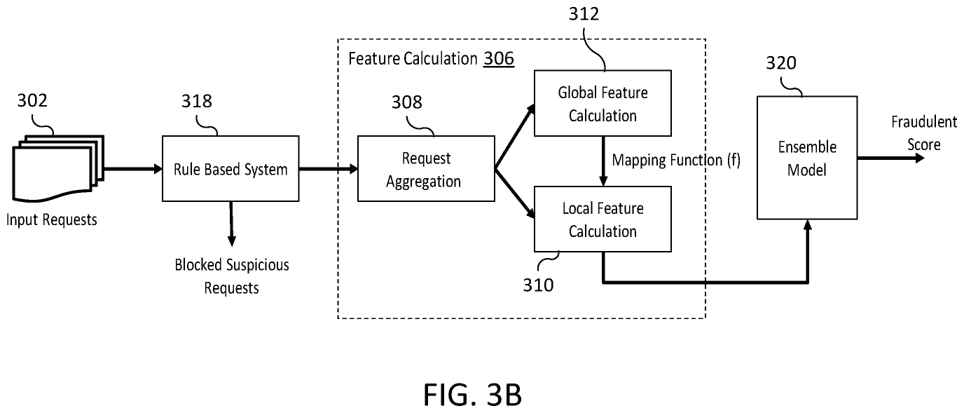

FIG. 3A illustrates an example block diagram for training one or more (e.g., supervised-learning based, etc.) prediction models implemented in a fraud detector (e.g., 210 of FIG. 2, etc.) in a model training phase, according to an embodiment. The fraud detector 210 in the model training phase as illustrated in FIG. 3A may be implemented by one or more computing devices. The one or more computing devices comprise any combination of hardware and software configured to implement the various logical components described herein, including components such as a ground truth preparation block 304, a feature calculation block 306, a model training block 314 and a save/store trained model block 316. For example, the one or more computing devices may include one or more memories storing instructions for implementing the various components described herein, one or more hardware processors configured to execute the instructions stored in the one or more memories, and various data repositories in the one or more memories for storing data structures utilized and manipulated by the various components.

Operations performed in the various blocks as illustrated in FIG. 3A may be implemented and/or performed in a variety of systems, including a content service subscription system (e.g., 108 of FIG. 1 and FIG. 2, etc.) in a system 100 such as described above. In an embodiment, operations performed in each of the blocks described below may be implemented using one or more computer programs, other software elements, and/or digital logic in any of a general-purpose computer or a special-purpose computer, while performing data retrieval, transformation, and storage operations that involve interacting with and transforming the physical state of memory of the computer. FIG. 3A illustrates but one example block diagram for training prediction models implemented in a fraud detector. Other block diagrams and/or configurations may involve additional or fewer blocks, in potentially varying arrangements.

Fraud detector 210 may be coupled to subscription web server(s) 208 via one or more networks, such as the Internet. Via these one or more networks, fraud detector 210 or feature calculation block 306 therein can operate with a number of subscription web server(s) 208 (e.g., web portals, websites, etc.) to collect and process client-device-originated input requests 302—e.g., originated from client devices 116, etc.—for content service subscriptions.

Some or all of the input requests 302 may be originated from web/mobile applications running on client device(s) 116. Some of the web/mobile applications may be available from (e.g., official, relatively reliable, with relatively rigorous certification processes, etc.) app stores for downloads/installations. Some others of the web/mobile applications may be obtained from other application sources that do not have relatively rigorous certification processes. Each of input requests 302 may comprise one or more content service subscription messages (e.g., client-originated request and/or response messages, etc.). Example content service subscription messages may include, but are not necessarily limited to only, any, some or all of: HTML messages, XML messages, SOAP messages, JSON messages, AJAX messages, RESTful messages, and so forth.

As illustrated in FIG. 3A, feature calculation block 306 in fraud detector 210 includes a request aggregation block 308, a global feature calculation block 312 and a local feature calculation block 310.

Fraud detector 210 collects (e.g., in real time, in near real time, in batches, in non-real time, etc.) content service subscription messages representing input requests 302 from subscription web servers 208 using one or more data collection methods among a wide variety of data collection methods. Any, some or all of these data collection methods may be implemented based at least in part on one or more of: Kafka-based data pipelines/streams, Spark Streaming, Storm Topology, S3, Cassandra, Flume, Amazon Kinesis, Spark SQL, Amazon Redshift, Amazon RDS, and so forth.

In request aggregation block 308, fraud detector 210 may perform a number of message processing operations—which may include, but are not necessarily limited to only, any, some or all of: data/message aggregation, message authentication, message validation, data population, data correlation, data extraction, message transformation, etc.—on some or all of the content service subscription messages as related to input request 302. Any, some or all of the message processing operations may be performed on a global basis across some or all input requests 302, or on an individual input request basis, or on an individual input request group (or proper subset) basis. In some embodiments, request aggregation block 308 comprises generating unique identifiers for respective input request identified through message aggregation. These unique identifier may be generated based on one or more of: client device properties, browser properties, MSISDNs (each of which may be directly used as a unique identifier). By way of example but not limitation, in some non-limiting implementation examples, in request aggregation block 308, messages aggregation and transformation may be performed to generate transformed messages with unique identifiers (e.g., MSISDN, etc.) for respective input requests. After the message aggregation and transformation performed in request processing block 308, during feature calculation such as in one or both of local feature calculation block 310 and global feature calculation block 312, aggregated messages may be validated. For instance, if a count (or the total number) of desired logs/messages in all aggregated messages of an input request is not found for the input request, the input request with the aggregated messages may be determined or classified as already fraudulent.

In local feature calculation block 310, fraud detector 210 uses the collected content service subscription messages as aggregated/organized based on the individual input requests to generate a set (e.g., a plurality, etc.) of local features related to the input requests 302. Some or all of the local features in the set of local features may be extracted from the content service subscription messages on an individual input request basis (or possibly even on an individual message basis if an input request is represented by multiple messages). Additionally, optionally or alternatively, the set of local features may include local features generated or deduced from external information (e.g., HTTP logs on web servers as collected through Kafka based data pipelines/streams, etc.) related to input requests 302.

Fraud detector 210 may determine a publisher ID (e.g., identifier, an attribute/parameter value uniquely identifying a publisher web server, etc.) associated with an input request (e.g., each input request in input requests 302, etc.). The publisher ID may be identified or extracted from one or more content service subscription messages relating to the input request. Based on the publisher ID, fraud detector 210 may further determine the number of input requests and the rate of input requests for the publisher identified by the publishers ID. The number of input requests and/or the rate of input requests may be measured for a specific time interval such as the past five minutes, the past hours, the past day, etc.

Fraud detector 210 also may determine a specific user agent associated with the input request. From the user agent and/or HTTP header, fraud detector 210 may determine one or more of: a specific type of browser, a specific operating system, a specific device model, a specific source attribute/parameter value, a specific x-requested-with attribute/parameter value (e.g., with AJAX, without AJAX, etc.), a specific application, a specific application type, a specific software vendor/provider providing/implementing the specific application, a specific software version (e.g., major and/or minor version numbers, etc.) of the specific application, any URL and/or email address for contacting the specific software vendor/provider, etc. For example, fraud detector 210 may determine one or more of a specific source attribute/parameter value, a specific x-requested-with attribute/parameter value from HTTP logs, etc.

User behaviors before and after the input request may be determined or measured through JavaScript code associated with a content service subscription web link, through analyzing message contents, through analyzing timing information of messages, and so forth. Messages representing the input request may include, but are not necessarily limited to only, one or more of: HTML messages, XML messages, SOAP messages, JSON messages, AJAX messages, RESTful messages, etc., that are received by one or more of: publisher web servers, subscription web servers, publishing networks, etc.

Some or all of the above properties and/or attributes/parameters of the input request may be determined in local feature calculation block 310 intrinsically (e.g., from the information content of the content service subscription messages, etc.) or extrinsically (e.g., from other than the information content of the content service subscription messages, etc.) from the content service subscription messages, and may be included in the set of local features for the input request.

One or more local features of an input request as generated by fraud detector 210 may be related to states of a client device's UI when an application from which an input request is made is running on the client device. Additionally, optionally or alternatively, one or more local features as generated by fraud detector 210 may be related to how invitational messages (e.g., ads, etc.) are presented on a client device such as whether any of the invitational messages represents a hidden invitational message (or ad), a stacking of multiple invitational message (or ads), and so forth. Additionally, optionally or alternatively, one or more local features as generated by fraud detector 210 may be related to how clicks are made on content service subscription web links presented in the invitational messages (or ads) such as whether any of these clicks is likely to be an unintentionally click and selection on a web view while a user of the client device is interacting with application UI elements, whether any of these clicks is like to be from an unexpectedly popped up on top of an exit button when the user wants to exit an app; etc.

Activity features such as a specific number of queries to a web server (e.g., a subscription web server, etc.), specific types of the queries, a specific number of page views, specific types of page views, a specific number of videos watched, specific types of videos watched, and so forth, made from a client device initiating/originating the input request may be determined in local feature calculation block 310 with respect to the input request (e.g., each input request in input requests 302, etc.) and included in the set of local features for the input request.

Additionally, optionally or alternatively, the collected content service subscription messages as aggregated/organized based on the individual input requests in request aggregation block 308 in feature calculation block 306 can be processed by operations in global feature calculation block 312.

In global feature calculation block 312, fraud detector 210 generates global features related to input requests 302. Some or all of the global features may be extracted in global feature calculation block 312 from the content service subscription messages as processed in request aggregation block 308 across some or all of input requests 302. Additionally, optionally or alternatively, the global features may include those generated or deduced in global feature calculation block 312 from external information related to the input requests 302.

Global features as described herein may be determined or calculated based on information relating to many different users (or many different client devices), rather than a specific user (or a specific client device). Global features may also be determined or calculated based on information relating to many different types of invitational messages, rather than a specific type of invitation message that causes a user (or a client device) to send any particular input request. Global features may be determined or calculated based on information relating to many different types of applications, rather than a specific type of application that causes a user (or a client device) to send any particular input request. Global features may be determined or calculated based on information relating to many different types of web views, rather than a specific type of web view (or a specific web portal, a website, etc.) that causes a user (or a client device) to send any particular input request. Global features may be determined or calculated based on information relating to many different geographic locations, rather than a specific geographic location in which a user (or a client device) sends any particular input request. Global features may be determined or calculated based on information relating to many different networks (e.g., access networks, service provider networks, publisher networks, etc.), rather than a specific network in which a user (or a client device) sends any particular input request.

In global feature calculation block 312, fraud detector 210 may determine specific churn rate(s) for each individual publisher and/or across all publishers, specific churn rate(s) for each individual application and/or across all applications, specific churn rate(s) for each individual geo-location and/or across all geo-locations, specific conversion rate(s) for each individual publisher and/or across all publishers, specific conversion rate(s) for each individual application and/or across all applications, specific conversion rate(s) for each individual geo-location and/or across all geo-locations, and so forth, across some or all of input requests 302.

As used herein, a churn rate may be calculated by determining how many subscribers (e.g., as identified by unique user IDs, as identified by unique subscriber IDs, etc.) unsubscribed in a given time period, or by determining how many subscribers subscribedontent service subscriptions in the given time period.

A conversion rate may be calculated by taking the total number of conversions/signups in a given time period and dividing that by the total number of clicks (or client-device originated web link selections for sending input requests for content service subscriptions regardless of whether these input requests lead to conversions/signups for the content service subscriptions) that can be tracked to a conversion/signup during the same time period. Additionally, optionally or alternatively, a conversion rate may be calculated by taking the total number of invitation messages clicked by users (e.g., clicks, etc.) and dividing that by the total number of invitation messages displayed (e.g., impressions, etc.).

In global feature calculation block 312, fraud detector 210 may determine application availability in official app stores for different applications (e.g., running on client devices 116, 30 applications, 50 applications, etc.) from which some or all of input requests 302 are originated.

Some or all of the above properties and/or attributes/parameters across some or all of input requests 302 may be determined in global feature calculation block 312 and included in the global features for some or all of input requests 302.

Different user IDs may be used to respectively identify different users in a user population (or different client devices 116) generating or originating input requests 302 with or without knowledge or permission of these different users.

Example user IDs used to identify different users in the user population may include, but are not necessarily limited to only, any combination of: mobile identification numbers, mobile subscription identification numbers, international mobile subscriber identities, equipment serial numbers, mobile equipment identifiers, SIM numbers, mobile serial numbers, mobile phone numbers, user login names to mobiles, emails, app stores, etc.

Some or all of the global features as generated or calculated in global feature calculation block 312 can be assigned to an input request (among input requests 302) of a user (or a user ID) based on mapping functions (denoted as “f”).

Example mapping functions “f” that are used to generate mapped features for an input request may include, but are not necessarily limited to only, any of: statistical functions, selector functions, binary functions, probability density function, histograms, distributions, etc.

In an example, a mapping function “f” may represent a statistical function such as max( ), avg( ), sqrt( ), etc. By way of illustration but not limitation, two applications may be used to generate input requests 302. One of the two applications may generate a first maximum number of subscriptions daily, whereas the other of the two applications may generate a second maximum number of subscriptions daily. In some embodiments, the larger of these two maximum numbers may be mapped to an input request as a mapped feature for the input request. Additionally, optionally or alternatively, other global features such as a mean value may be mapped to the input request as other mapped features for the input request.

In another example, a mapping function “f” may represent a binary function. By way of illustration but not limitation, many different applications may be used to generate input requests 302. Some of the applications may be available for downloading in an app store that subjects these applications to a relatively rigorous certification process, whereas the other applications may be from other application downloading sources that may or may not subject these applications to relatively rigorous certification process(es). In some embodiments, a binary value to indicate whether an application that originates an input request may be mapped to the input request as a mapped feature for the input request. Additionally, optionally or alternatively, other global features related to the application or applications available in the app store may be mapped to the input request as other mapped features for the input request.

In the model training phase, a prediction model as described herein may be trained with a training dataset comprising a plurality of training instances generating from (training) input requests for service subscriptions and (training) labels or ground truths prepared (e.g., by fraud detector 210 in ground truth preparation block 304, etc.) for the input requests. The training input requests can be used by the ML-based subsystem to calculate global and/or local features on an individual input request basis, across some or all of the input requests, etc.

Each training instance in the training dataset may comprise (1) an input feature vector with vector components in the form of input features (e.g., local features, features mapped from global features to the input request, etc.) generated by the ML-based subsystem from intrinsic and extrinsic information related to an input request and (2) a label or ground truth for the input request.

The label or ground truth for the input request may indicate whether the input request is fraudulent or non-fraudulent. Additionally, optionally or alternatively, the label or ground truth for the input request may indicate whether the input request is likely (e.g., by way of a numeric measure, a percentile value, etc.) to be fraudulent or non-fraudulent.

The label or ground truth for the input request may be determined, labeled and/or set in a ground truth preparation. In an example, the label or ground truth for the input request may be set to true (e.g., the input request is fraudulent, etc.) when a complaint from a user or an operator is received, and may be set to false (e.g., the input request is non-fraudulent, etc.) when recurring charges have been made with no complaint from a user or an operator. In another example, the label or ground truth for the input request may be set to a relatively high numeric value (e.g., the input request is likely to be fraudulent, etc.) when the input request is originated from a domain that has been identified in a WASPA as with a high likelihood for fraud occurrences, and may be set to a relatively low numeric value (e.g., the input request is likely to be non-fraudulent, etc.) when the input request is originated from a domain that has not been identified in the WASPA as with a high likelihood for fraud occurrences. In yet another example, the label or ground truth for the input request may be set by a user such as a domain expert, a customer service professional, a system administrator, an authorized user, etc.

In model training block 314, fraud detector 210 trains the prediction model(s) with local features related to individual input requests (in individual training/validating/testing instances) for which individual target values (e.g., labels, ground truths, etc.) are to be predicted by the prediction model(s), as well as global features related to other input requests other than the individual input requests from which the local features are derived. In some embodiments, training a prediction model as described herein may be performed through solving an optimization problem in which an error function (or an objective function) representing errors between targeted values (e.g., labels, ground truths, etc.) and predicted/estimated values by the prediction model is minimized. Prediction model operational parameters (e.g., optimized functional forms, optimized weights, optimal hyper parameters, etc.) generated in model training block 314 may be saved by fraud detector 210 in save trained model block 316 locally or remotely, for example in one or more data stores (e.g., in memory, in persisted data store(s), in database(s), in file(s), etc.).

Thus, under techniques as described herein, the prediction model(s) are adapted to taking into account not only trends, cases, scenarios, local features, etc., in the individual input requests, but also trends, cases, scenarios, global features, etc., across some or all of input requests, some or all of applications, some or all of geographic regions, some or all of networks (e.g., mobile networks, service provider networks, publisher networks, etc.), some or all of one or more specific types of client devices (e.g., Android, PC, iPhone, etc.), some or all of one or more specific OSs, etc. For example, if a global trend as represented in the global features indicates that a particular application generates a higher percentage of fraudulent input requests as compared with another application, such global trend picked up in the global features can be taken into account by the prediction model(s) in generating predictions/estimations through training that incorporate the global features.

As a result, if the local features can be used to train the prediction model(s) to achieve a relatively high accuracy such as a 70% accuracy, a combination of the local features and the global features can be used to train the prediction model(s) to achieve a much higher accuracy such as 90% accuracy, 98% accuracy, etc.

FIG. 3B illustrates an example block diagram for applying (in actual input request processing in real time or in near real time) one or more (e.g., supervised-learning based, etc.) prediction models implemented in a fraud detector (e.g., 210 of FIG. 2, etc.) in a model testing/scoring phase, according to an embodiment. The fraud detector 210 as illustrated in FIG. 3B may be implemented by one or more computing devices. The one or more computing devices comprise any combination of hardware and software configured to implement the various logical components described herein, including components such as a rule based system (or a rule based fraud detection/protection subsystem), feature calculation block 306 and an ensemble model block 320. For example, the one or more computing devices may include one or more memories storing instructions for implementing the various components described herein, one or more hardware processors configured to execute the instructions stored in the one or more memories, and various data repositories in the one or more memories for storing data structures utilized and manipulated by the various components.

Operations performed in the various blocks as illustrated in FIG. 3B may be implemented and/or performed in a variety of systems, including a content service subscription system (e.g., 108 of FIG. 1 and FIG. 2, etc.) in a system 100 such as described above. In an embodiment, operations performed in each of the blocks described below may be implemented using one or more computer programs, other software elements, and/or digital logic in any of a general-purpose computer or a special-purpose computer, while performing data retrieval, transformation, and storage operations that involve interacting with and transforming the physical state of memory of the computer. FIG. 3B illustrates but one example block diagram for applying prediction models implemented in a fraud detector. Other block diagrams and/or configurations may involve additional or fewer blocks, in potentially varying arrangements.

As illustrated with FIG. 3A, in FIG. 3B, fraud detector 210 may be coupled to subscription web server(s) 208 via one or more networks, such as the Internet. Via these one or more networks, fraud detector 210 or feature calculation block 306 therein can operate with a number of subscription web server(s) 208 (e.g., web portals, websites, etc.) to collect and process client-device-originated input requests 302—e.g., originated from client devices 116, etc.—for content service subscriptions.

Some or all of the input requests 302 may be originated from web/mobile applications running on client device(s) 116. Some of the web/mobile applications may be available from (e.g., official, relatively reliable, with relatively rigorous certification processes, etc.) app stores for downloads/installations. Some others of the web/mobile applications may be obtained from other application sources that do not have relatively rigorous certification processes. Each of input requests 302 may comprise one or more content service subscription messages. Example content service subscription messages may include, but are not necessarily limited to only, any, some or all of: HTML messages, XML messages, SOAP messages, JSON messages, AJAX messages, RESTful messages, and so forth.

Content service subscription messages representing input requests 302 can be collected from subscription web servers 208 using one or more data collection methods among a wide variety of data collection methods. Any, some or all of these data collection methods may be implemented based at least in part on one or more of: Kafka-based data pipelines/streams, Spark Streaming, Storm Topology, S3, Cassandra, Flume, Amazon Kinesis, Spark SQL, Amazon Redshift, Amazon RDS, and so forth.

In block 318, the input request may be first processed by a rule-based fraud detection/protection subsystem in fraud detector 210. The rule-based fraud detection/protection subsystem may apply a set of rules to check different attributes, parameters, properties, etc., of an incoming input request to decide whether the input request is (e.g., likely to be, etc.) fraudulent or non-fraudulent. Example rules may include, but are not necessarily limited to only, those generated from heuristics, expert knowledges, user input, UI interactive states, etc.

The rule-based subsystem may incorporate features/techniques implemented with available with browsers (e.g., Chrome, Android, Safari, Firefox, etc.) and/or mobile/web applications. The rule-based subsystem may verify or determine whether input requests are from regions, geographies, applications, networks, domains, etc., that are identified as likely to be generating frauds, for example through one or more lists (e.g., block lists, warning lists, WASPA list(s), region-based lists, etc.) and block some or all of these input requests if verified or determined so. These lists may contain or specify names of (e.g., high-risk, etc.) domains where fraud is occurring.

To identify whether an input request is likely to be fraudulent or non-fraudulent, the rule-based subsystem may take into account whether an application from which an input request is made is available in one or more app stores. Additionally, optionally or alternatively, the rule-based subsystem may take into account attributes/parameters (e.g., user-agent specification, etc.) related to the input request including but not limited to whether the input request is an in-application request; whether the application is an Android app or iOS app; an version of the application; an OS version of the client device; whether the application is a fully native app or a WebView-based hybrid app; etc.

In response to determining that input request(s) for service subscription(s) are (e.g., likely to be, etc.) fraudulent, the rule-based fraud detection/protection system blocks the input request(s) (denoted as “blocked suspicious requests”). On the other hand, in response to determining that input request(s) for service subscription(s) are not (e.g., likely to be, etc.) fraudulent, the rule-based fraud detection/protection system can pass the input request(s) to an ML-based fraud detection/protection model in fraud detector 210, or request aggregation block 308 implemented therein, for further processing.

In request aggregations block 308, fraud detector 210 may perform a number of message processing operations—which may include, but are not necessarily limited to only, any, some or all of: data/message aggregation, message authentication, message validation, data population, data correlation, data extraction, message transformation, etc.—on some or all of the content service subscription messages as related to input request 302. Any, some or all of the message processing operations may be performed on a global basis across some or all input requests 302, or on an individual input request basis, or on an individual input request group (or proper subset) basis. By way of example but not limitation, in some non-limiting implementation examples, in request aggregation block 308, messages aggregation and transformation may be performed to generate transformed messages with unique identifiers (e.g., MSISDN, etc.) for respective input requests. After the message aggregation and transformation performed in request processing block 308, during feature calculation such as in one or both of local feature calculation block 310 and global feature calculation block 312, aggregated messages may be validated. For instance, if a count (or the total number) of desired logs/messages in all aggregated messages of an input request is not found for the input request, the input request with the aggregated messages may be determined or classified as already fraudulent.

In local feature calculation block 310, fraud detector 210 uses the collected content service subscription messages as aggregated/organized based on the individual input requests to generate a set (e.g., a plurality, etc.) of local features related to the input requests 302. Some or all of the local features in the set of local features may be extracted from the content service subscription messages on an individual input request basis (or possibly even on an individual message basis if an input request is represented by multiple messages). Additionally, optionally or alternatively, the set of local features may include local features generated or deduced from external information (e.g., HTTP logs on web servers as collected through Kafka based data pipelines/streams, etc.) related to input requests 302.

Some or all of the local features as generated in local feature calculation block 310 of FIG. 3B may be the same as or similar to those generated in the model training phase as illustrated with local feature calculation block 310 of FIG. 3A.

In global feature calculation block 312 of FIG. 3B, fraud detector 210 generates global features related to input requests 302. Some or all of the global features may be extracted in global feature calculation block 312 from the content service subscription messages as processed in request aggregations block 308 across some or all of input requests 302. Additionally, optionally or alternatively, the global features may include those generated or deduced in global feature calculation block 312 from external information related to the input requests 302.

Some or all of the local features as generated in global feature calculation block 312 of FIG. 3B may be the same as or similar to those generated in the model training phase as illustrated with global feature calculation block 312 of FIG. 3A.

Some or all of the global features as generated or calculated in global feature calculation block 312 can be assigned to an input request (among input requests 302) of a user (or a user ID) based on mapping functions (denoted as “f”), which may be the same as or similar to those mapping functions used in the model training phase.

In the model testing/scoring phase, a prediction model as described herein may be applied with to-be-predicted input requests, for example derived/generated from live traffic. The to-be-predicted input requests can be used by the ML-based subsystem to calculate global and/or local features on an individual input request basis, across some or all of the input requests, etc.

An input feature vector with vector components in the form of input features (e.g., local features, features mapped from global features to the input request, etc.) may be generated by the ML-based subsystem from intrinsic and extrinsic information related to an input request.

In ensemble model block 320, fraud detector 210 uses the prediction model(s), as specified/defined by the prediction model operational parameters generated in the training phase, to generate predicted/estimated values for individual fraud score(s) (or fraudulent score(s)) for individual to-be-predicted input requests for service subscriptions. In the model testing/scoring phase, these predicted/estimated values for fraud scores may be used to determine whether each of the individual input requests is (e.g., likely to be, etc.) fraudulent or non-fraudulent.

The prediction model(s) in fraud detector 210 may classify an input request either as fraudulent or non-fraudulent. Additionally, optionally or alternatively, the prediction model(s) in fraud detector 210 may assign a fraud score representing a likelihood (e.g., a probability, a numeric value, a percentile value, a normalized value, etc.) of the input request being fraudulent or non-fraudulent. If the fraud score for the input request is below a minimum fraudulent score threshold (e.g., 20 percentiles, 30 percentiles, 50 percentiles, 20%, 30%, 50%, etc.), the input request is considered or determined as non-fraudulent.

In some embodiments, fraud detector 210 employs multiple prediction models (e.g., one based on neural networks and another based on gradient boosting, etc.) to generate predictions/estimations as to whether an input request is (e.g., likely to be, etc.) fraudulent or non-fraudulent. Each prediction model may generate a model-specific predicted/estimated value of a fraud score for the input request. Some or all of model-specific predicted/estimated values of the fraud score for the input request may be used (e.g., through non-weighted averaging, through weighted averaging, etc.) to generate a collective (e.g., final, etc.) predicted/estimated value of the fraud score. Additionally, optionally or alternatively, any parameters such as weight factors used in averaging the model-specific predicted/estimated values may be determined or optimized, for example, along with prediction model operational parameters specifying/defining the prediction models, in a model training phase as described herein.

As compared with the ML-based fraud detection/protection subsystem, the rule-based fraud detection/protection subsystem may not be so readily or timely adaptable, as heuristics, expert knowledge, user-based input, complaint processing, etc., underlying the rules may take longer time to develop and verify. It is quite likely that fraudsters can come up new fraud schemes and methods faster than rules that are to be generated in the rule-based fraud detection/protection subsystem to prevent these fraud schemes and methods.

Techniques as described herein can be implemented to continuously train, validate and/or test (e.g., periodically, from time to time, automatically, on demand, in parallel with actual input request processing, etc.) the prediction model(s) in the ML-based fraud detection/protection subsystem through supervised learning to ensure these prediction model(s) to be continuously adapted to volatile and dynamic natures/trends of fraud behaviors and wide ranges/varieties of fraud types that have occurred in the past, are occurring at present, or will occur in future.

A number of factors may be used to determine whether the prediction model(s) in the ML-based fraud detection/protection subsystem should be trained, validated and/or tested at a given time. For example, a global feature determined across some or all of input requests may represent a distribution (e.g., a value distribution, a time distribution, etc.) that changes or varies over time. In response to determining that one or more changes (e.g., individual changes, aggregated changes, weighted average changes, non-weighted average changes, etc.) in distribution(s) of one or more global features exceed one or more global feature change thresholds, a system as described herein may cause an individual prediction model, some or all of the prediction model(s), etc., to be re-trained, re-validated, and/or re-tested.

One or more time schedules may be set for training, validating and/or testing any, some or all of the prediction model(s) in the ML-based fraud detection/protection subsystem. For example, the system may use a time schedule to determine that one of the prediction model(s) in the ML-based fraud detection/protection subsystem is to be re-trained, re-validated and/or re-tested every X days (e.g., 7 days, 10 days, etc.).

The system may also monitor whether any (e.g., new fraud, etc.) application originating input request(s) processed by the system appears in one or more lists that identify fraud applications. For example, the system can monitor a global fraud app list which if updated will result in triggering of model retraining and re-testing (scoring with actual to-be-predicted input requests). In response to determining that an application originating input request(s) appears in a fraud application identification list, the system can re-train, re-validate and/or re-test some or all of the prediction model(s) in the ML-based fraud detection/protection subsystem.

The system may measure, in offline or in real time, precision and recall (e.g., false positives, false negatives, etc.) of classifications/predictions made by each of the prediction model(s) in the ML-based fraud detection/protection subsystem. If it is determined that a prediction model fails to meet, or stay above, a (e.g., classification, prediction, etc.) accuracy threshold (e.g., below 45%, 50%, 75%, etc.), the system can re-train, re-validate and/or re-test the prediction model.

The system may measure, in offline or in real time, precision and recall (e.g., false positives, false negatives, etc.) of classifications/predictions made by a combination of the prediction model(s) in the ML-based fraud detection/protection subsystem. If it is determined that the combination of the prediction model(s) fails to meet, or stay above, a (e.g., classification, prediction, etc.) accuracy threshold (e.g., below 90%, 95%, 98%, etc.), the system can re-train, re-validate and/or re-test some or all of the prediction model(s).

3.2. Example Process Flows

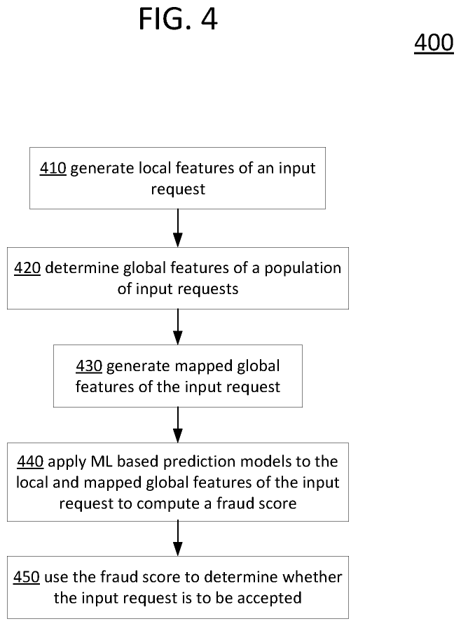

FIG. 4 illustrates an example flow 400 for generating subscription(s) for services, according to an embodiment. The various elements of flow 400 may be performed in a variety of systems, including systems such as system 100 described above. In an embodiment, each of the processes described in connection with the functional blocks described below may be implemented using one or more computer programs, other software elements, and/or digital logic in any of a general-purpose computer or a special-purpose computer, while performing data retrieval, transformation, and storage operations that involve interacting with and transforming the physical state of memory of the computer. Flow 400 illustrates but one example flow for generating subscription(s). Other flows may involve additional or fewer steps, in potentially varying arrangements.

Block 410 comprises generating, based at least in part on one or more messages originated from a client device that represent an input request for service subscription, one or more local features of the input request.

Block 420 comprises determining, based at least in part on a population of input requests originated from a population of client devices, one or more global features of the input requests.

Block 430 comprises generating, from the one or more global features via one or more mapping functions, one or more mapped global features of the input request.

Block 440 comprises applying one or more machine learning (ML) based prediction models to the one or more local features and the one or more mapped global features of the input request to compute a fraud score for the input request.

Block 450 comprises using the fraud score for the input request to determine whether the input request for service subscription is to be accepted.

3.3. Variations

While flow 400 describes a flow in which it is assumed that subscription generation will be performed, in other embodiments, the flows may include more or fewer steps as described.

### 4.0. Example Embodiments

Examples of some embodiments are represented, without limitation, in the following paragraphs:

According to an embodiment, a method comprises: generating, based at least in part on one or more messages originated from a client device that represent an input request for service subscription, one or more local features of the input request; determining, based at least in part on a population of input requests originated from a population of client devices, one or more global features of the input requests; generating, from the one or more global features via one or more mapping functions, one or more mapped global features of the input request; applying one or more machine learning (ML) based prediction models to the one or more local features and the one or more mapped global features of the input request to compute a fraud score for the input request; using the fraud score for the input request to determine whether the input request for service subscription is to be accepted.

In an embodiment, the one or more ML based prediction models are trained by a training dataset comprising a plurality of training instances; each training instance in the plurality of training instances comprises one or more training local features and one or more mapped training global features of a training input request and a training label; the one or more training local features of the training input request are of same feature types as the one or more local features of the input request; the one or more mapped training global features are mapped from one or more training global features of a population of training input requests via the one or more mapping functions; the one or more training global features are of same feature types as the one or more global features.

In an embodiment, the one or more ML based prediction models include one or more of: artificial neural networks, multi-layer neural networks or perceptron, convolutional neural networks, deep neural networks, feedforward neural networks, recurrent neural networks, model/algorithms based on boosting, framework such AdaBoost, gradient boosting, etc., regression analysis models, linear regression models, non-linear regression models, support vector machines, decision trees, Gaussian process regression models, and so forth.

In an embodiment, the one or more ML based prediction models include a ML based prediction model to be re-trained based on one or more of: a model re-training time schedule, a drop in prediction accuracy, inclusions of one or more input-request originating applications in one or more fraudulent application lists, inclusions of one or more input-request originating applications in one or more app stores, changes in distributions of the one or more global features, etc.

In an embodiment, the method as described herein further comprises: determining whether the fraud score for the input request is below a minimum fraudulent score threshold; in response to determining that the fraud score for the input request is below the minimum fraudulent score threshold, determining that the input request is not fraudulent.

In an embodiment, the at least one of the one or more client-device-originated messages representing the input request confirms a subscription of a user operating the client device to one or more cloud-based media content services.

In an embodiment, the input request is determined to be non-fraudulent by a rule based system applying a set of fraud detection rules to the input request.

In an embodiment, the set of fraud detection rules are generated based on one or more of: heuristics, expert knowledges, user input, UI interactive states, Wireless Application Service Providers' Association (WASPA) blocking lists, and so forth.

In an embodiment, the one or more messages includes one or more of: HTML messages, XML messages, SOAP messages, JSON messages, AJAX messages, RESTful messages, etc.

In an embodiment, the one or more messages are originated from the client device by way of one or more of: web views or applications running on the client device.

According to an embodiment, a system comprises: a local feature generator that generates, based at least in part on one or more messages originated from a client device that represent an input request for service subscription, one or more local features of the input request; a global feature generator that determines, based at least in part on a population of input requests originated from a population of client devices, one or more global features of the input requests; wherein the global feature generator generates, from the one or more global features via one or more mapping functions, one or more mapped global features of the input request; a model predictor that applies one or more machine learning (ML) based prediction models to the one or more local features and the one or more mapped global features of the input request to compute a fraud score for the input request; a fraud detector that uses the fraud score for the input request to determine whether the input request for service subscription is to be accepted.

Other examples of these and other embodiments are found throughout this disclosure.

### 5.0. Implementation Mechanism—Hardware Overview

According to one embodiment, the techniques described herein are implemented by one or more special-purpose computing devices. The special-purpose computing devices may be desktop computer systems, portable computer systems, handheld devices, smartphones, media devices, gaming consoles, networking devices, or any other device that incorporates hard-wired and/or program logic to implement the techniques. The special-purpose computing devices may be hard-wired to perform the techniques, or may include digital electronic devices such as one or more application-specific integrated circuits (ASICs) or field programmable gate arrays (FPGAs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, or FPGAs with custom programming to accomplish the techniques.

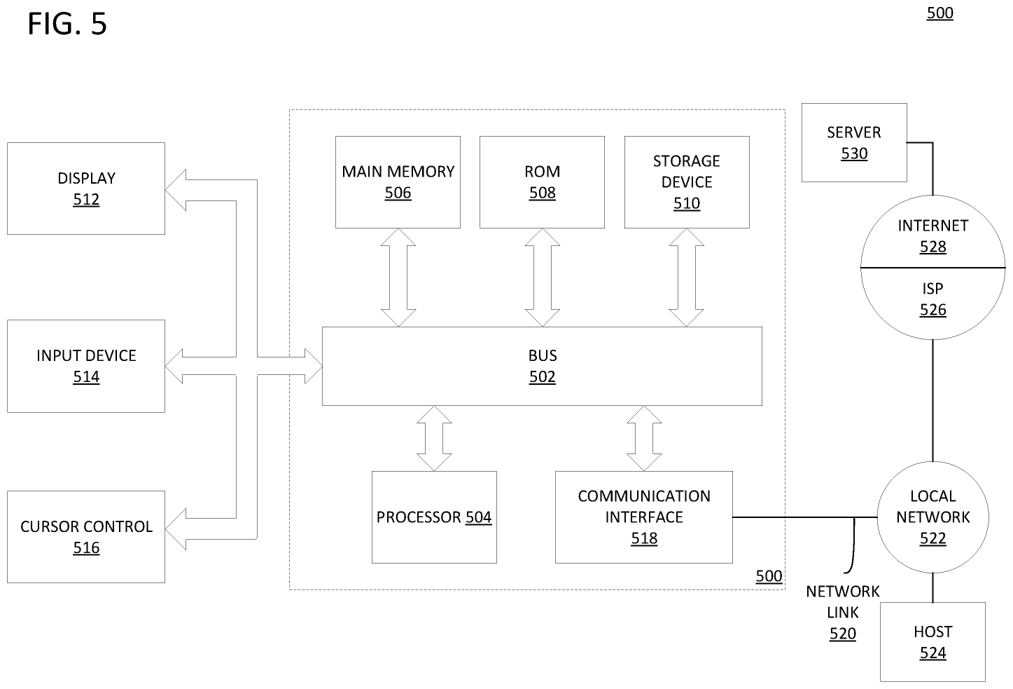

FIG. 5 is a block diagram that illustrates a computer system 500 utilized in implementing the above-described techniques, according to an embodiment. Computer system 500 may be, for example, a desktop computing device, laptop computing device, tablet, smartphone, server appliance, computing main image, multimedia device, handheld device, networking apparatus, or any other suitable device.

Computer system 500 includes one or more busses 502 or other communication mechanism for communicating information, and one or more hardware processors 504 coupled with busses 502 for processing information. Hardware processors 504 may be, for example, a general purpose microprocessor. Busses 502 may include various internal and/or external components, including, without limitation, internal processor or memory busses, a Serial ATA bus, a PCI Express bus, a Universal Serial Bus, a HyperTransport bus, an Infiniband bus, and/or any other suitable wired or wireless communication channel.

Computer system 500 also includes a main memory 506, such as a random access memory (RAM) or other dynamic or volatile storage device, coupled to bus 502 for storing information and instructions to be executed by processor 504. Main memory 506 also may be used for storing temporary variables or other intermediate information during execution of instructions to be executed by processor 504. Such instructions, when stored in non-transitory storage media accessible to processor 504, render computer system 500 into a special-purpose machine that is customized to perform the operations specified in the instructions.

Computer system 500 further includes one or more read only memories (ROM) 508 or other static storage devices coupled to bus 502 for storing static information and instructions for processor 504. One or more storage devices 510, such as a solid-state drive (SSD), magnetic disk, optical disk, or other suitable non-volatile storage device, is provided and coupled to bus 502 for storing information and instructions.

Computer system 500 may be coupled via bus 502 to one or more displays 512 for presenting information to a computer user. For instance, computer system 500 may be connected via an High-Definition Multimedia Interface (HDMI) cable or other suitable cabling to a Liquid Crystal Display (LCD) monitor, and/or via a wireless connection such as peer-to-peer Wi-Fi Direct connection to a Light-Emitting Diode (LED) television. Other examples of suitable types of displays 512 may include, without limitation, plasma display devices, projectors, cathode ray tube (CRT) monitors, electronic paper, virtual reality headsets, braille terminal, and/or any other suitable device for outputting information to a computer user. In an embodiment, any suitable type of output device, such as, for instance, an audio speaker or printer, may be utilized instead of a display 512.

In an embodiment, output to display 512 may be accelerated by one or more graphics processing unit (GPUs) in computer system 500. A GPU may be, for example, a highly parallelized, multi-core floating point processing unit highly optimized to perform computing operations related to the display of graphics data, 3D data, and/or multimedia. In addition to computing image and/or video data directly for output to display 512, a GPU may also be used to render imagery or other video data off-screen, and read that data back into a program for off-screen image processing with very high performance. Various other computing tasks may be off-loaded from the processor 504 to the GPU.

One or more input devices 514 are coupled to bus 502 for communicating information and command selections to processor 504. One example of an input device 514 is a keyboard, including alphanumeric and other keys. Another type of user input device 514 is cursor control 516, such as a mouse, a trackball, or cursor direction keys for communicating direction information and command selections to processor 504 and for controlling cursor movement on display 512. This input device typically has two degrees of freedom in two axes, a first axis (e.g., x) and a second axis (e.g., y), that allows the device to specify positions in a plane. Yet other examples of suitable input devices 514 include a touch-screen panel affixed to a display 512, cameras, microphones, accelerometers, motion detectors, and/or other sensors. In an embodiment, a network-based input device 514 may be utilized. In such an embodiment, user input and/or other information or commands may be relayed via routers and/or switches on a Local Area Network (LAN) or other suitable shared network, or via a peer-to-peer network, from the input device 514 to a network link 520 on the computer system 500.

A computer system 500 may implement techniques described herein using customized hard-wired logic, one or more ASICs or FPGAs, firmware and/or program logic which in combination with the computer system causes or programs computer system 500 to be a special-purpose machine. According to one embodiment, the techniques herein are performed by computer system 500 in response to processor 504 executing one or more sequences of one or more instructions contained in main memory 506. Such instructions may be read into main memory 506 from another storage medium, such as storage device 510. Execution of the sequences of instructions contained in main memory 506 causes processor 504 to perform the process steps described herein. In alternative embodiments, hard-wired circuitry may be used in place of or in combination with software instructions.

The term “storage media” as used herein refers to any non-transitory media that store data and/or instructions that cause a machine to operate in a specific fashion. Such storage media may comprise non-volatile media and/or volatile media. Non-volatile media includes, for example, optical or magnetic disks, such as storage device 510. Volatile media includes dynamic memory, such as main memory 506. Common forms of storage media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 502. Transmission media can also take the form of acoustic or light waves, such as those generated during radio-wave and infra-red data communications.

Various forms of media may be involved in carrying one or more sequences of one or more instructions to processor 504 for execution. For example, the instructions may initially be carried on a magnetic disk or solid state drive of a remote computer. The remote computer can load the instructions into its dynamic memory and use a modem to send the instructions over a network, such as a cable network or cellular network, as modulated signals. A modem local to computer system 500 can receive the data on the network and demodulate the signal to decode the transmitted instructions. Appropriate circuitry can then place the data on bus 502. Bus 502 carries the data to main memory 506, from which processor 504 retrieves and executes the instructions. The instructions received by main memory 506 may optionally be stored on storage device 510 either before or after execution by processor 504.

A computer system 500 may also include, in an embodiment, one or more communication interfaces 518 coupled to bus 502. A communication interface 518 provides a data communication coupling, typically two-way, to a network link 520 that is connected to a local network 522. For example, a communication interface 518 may be an integrated services digital network (ISDN) card, cable modem, satellite modem, or a modem to provide a data communication connection to a corresponding type of telephone line. As another example, the one or more communication interfaces 518 may include a local area network (LAN) card to provide a data communication connection to a compatible LAN. As yet another example, the one or more communication interfaces 518 may include a wireless network interface controller, such as an 802.11-based controller, Bluetooth controller, Long Term Evolution (LTE) modem, and/or other types of wireless interfaces. In any such implementation, communication interface 518 sends and receives electrical, electromagnetic, or optical signals that carry digital data streams representing various types of information.

Network link 520 typically provides data communication through one or more networks to other data devices. For example, network link 520 may provide a connection through local network 522 to a host computer 524 or to data equipment operated by a Service Provider 526. Service Provider 526, which may for example be an Internet Service Provider (ISP), in turn provides data communication services through a wide area network, such as the world wide packet data communication network now commonly referred to as the “Internet” 528. Local network 522 and Internet 528 both use electrical, electromagnetic or optical signals that carry digital data streams. The signals through the various networks and the signals on network link 520 and through communication interface 518, which carry the digital data to and from computer system 500, are example forms of transmission media.

In an embodiment, computer system 500 can send messages and receive data, including program code and/or other types of instructions, through the network(s), network link 520, and communication interface 518. In the Internet example, a server 530 might transmit a requested code for an application program through Internet 528, ISP 526, local network 522 and communication interface 518. The received code may be executed by processor 504 as it is received, and/or stored in storage device 510, or other non-volatile storage for later execution. As another example, information received via a network link 520 may be interpreted and/or processed by a software component of the computer system 500, such as a web browser, application, or server, which in turn issues instructions based thereon to a processor 504, possibly via an operating system and/or other intermediate layers of software components.

In an embodiment, some or all of the systems described herein may be or comprise server computer systems, including one or more computer systems 500 that collectively implement various components of the system as a set of server-side processes. The server computer systems may include web server, application server, database server, and/or other conventional server components that certain above-described components utilize to provide the described functionality. The server computer systems may receive network-based communications comprising input data from any of a variety of sources, including without limitation user-operated client computing devices such as desktop computers, tablets, or smartphones, remote sensing devices, and/or other server computer systems.

In an embodiment, certain server components may be implemented in full or in part using “cloud”-based components that are coupled to the systems by one or more networks, such as the Internet. The cloud-based components may expose interfaces by which they provide processing, storage, software, and/or other resources to other components of the systems. In an embodiment, the cloud-based components may be implemented by third-party entities, on behalf of another entity for whom the components are deployed. In other embodiments, however, the described systems may be implemented entirely by computer systems owned and operated by a single entity.

In an embodiment, an apparatus comprises a processor and is configured to perform any of the foregoing methods. In an embodiment, a non-transitory computer readable storage medium, storing software instructions, which when executed by one or more processors cause performance of any of the foregoing methods.

### 6.0. Extensions and Alternatives

As used herein, the terms “first,” “second,” “certain,” and “particular” are used as naming conventions to distinguish queries, plans, representations, steps, objects, devices, or other items from each other, so that these items may be referenced after they have been introduced. Unless otherwise specified herein, the use of these terms does not imply an ordering, timing, or any other characteristic of the referenced items.

In the drawings, the various components are depicted as being communicatively coupled to various other components by arrows. These arrows illustrate only certain examples of information flows between the components. Neither the direction of the arrows nor the lack of arrow lines between certain components should be interpreted as indicating the existence or absence of communication between the certain components themselves. Indeed, each component may feature a suitable communication interface by which the component may become communicatively coupled to other components as needed to accomplish any of the functions described herein.

In the foregoing specification, embodiments of the invention have been described with reference to numerous specific details that may vary from implementation to implementation. Thus, the sole and exclusive indicator of what is the invention, and is intended by the applicants to be the invention, is the set of claims that issue from this application, in the specific form in which such claims issue, including any subsequent correction. In this regard, although specific claim dependencies are set out in the claims of this application, it is to be noted that the features of the dependent claims of this application may be combined as appropriate with the features of other dependent claims and with the features of the independent claims of this application, and not merely according to the specific dependencies recited in the set of claims. Moreover, although separate embodiments are discussed herein, any combination of embodiments and/or partial embodiments discussed herein may be combined to form further embodiments.

Any definitions expressly set forth herein for terms contained in such claims shall govern the meaning of such terms as used in the claims. Hence, no limitation, element, property, feature, advantage or attribute that is not expressly recited in a claim should limit the scope of such claim in any way. The specification and drawings are, accordingly, to be regarded in an illustrative rather than a restrictive sense.

What is claimed is:

1. A method comprising:
generating, based at least in part on one or more messages originated from a client device that represent an input request for service subscription, one or more local features of the input request;
determining, based at least in part on a population of input requests originated from a population of client devices, one or more global features of the input requests;
generating, from the one or more global features via one or more mapping functions, one or more mapped global features of the input request;
applying one or more machine learning (ML) based prediction models to the one or more local features and the one or more mapped global features of the input request to compute a fraud score for the input request;
using the fraud score for the input request to determine whether the input request for service subscription is to be accepted.

2. The method of claim 1, wherein the one or more ML based prediction models are trained by a training dataset comprising a plurality of training instances, wherein each training instance in the plurality of training instances comprises one or more training local features and one or more mapped training global features of a training input request and a training label, wherein the one or more training local features of the training input request are of same feature types as the one or more local features of the input request, wherein the one or more mapped training global features are mapped from one or more training global features of a population of training input requests via the one or more mapping functions, and wherein the one or more training global features are of same feature types as the one or more global features.

3. The method of claim 1, wherein the one or more ML based prediction models include one or more of: artificial neural networks, multi-layer perceptron, convolutional neural networks, deep neural networks, feedforward neural networks, recurrent neural networks, models based on boosting frameworks, models based on AdaBoost, models based on gradient boosting, regression analysis models, linear regression models, non-linear regression models, support vector machines, decision trees, or Gaussian process regression models.

4. The method of claim 1, wherein the one or more ML based prediction models include a ML based prediction model to be re-trained based on one or more of: a model re-training time schedule, a drop in prediction accuracy, inclusions of one or more input-request originating applications in one or more fraudulent application lists, inclusions of one or more input-request originating applications in one or more app stores, or changes in distributions of the one or more global features.

5. The method of claim 1, further comprising:
determining whether the fraud score for the input request is below a minimum fraudulent score threshold;
in response to determining that the fraud score for the input request is below the minimum fraudulent score threshold, determining that the input request is not fraudulent.

6. The method of claim 1, wherein the at least one of the one or more client-device-originated messages representing the input request confirms a subscription of a user operating the client device to one or more cloud-based media content services.

7. The method of claim 1, further comprising:
filtering out suspicious input requests, among all received input requests, based on a rule-based system;
performing request aggregation with respect to the input request based on a unique identifier that uniquely identifies a user operating the client device, wherein the unique identifier represents one or more of: client device properties, browser properties, web view properties, or a mobile station international subscriber directory number (MSISDN).

8. The method of claim 1, wherein the input request is determined to be non-fraudulent by a rule based system applying a set of fraud detection rules to the input request.

9. The method of claim 8, wherein the set of fraud detection rules are generated based on one or more of: heuristics, expert knowledges, user input, UI interactive states, or Wireless Application Service Providers' Association (WASPA) blocking lists.

10. The method of claim 1, wherein the one or more messages includes one or more of: HTML messages, XML messages, SOAP messages, JSON messages, AJAX messages, or RESTful messages.

11. The method of claim 1, wherein the one or more messages are originated from the client device by way of one or more of: web views or applications running on the client device.

12. A system comprising:
a local feature generator that generates, based at least in part on one or more messages originated from a client device that represent an input request for service subscription, one or more local features of the input request;
a global feature generator that determines, based at least in part on a population of input requests originated from a population of client devices, one or more global features of the input requests;
wherein the global feature generator generates, from the one or more global features via one or more mapping functions, one or more mapped global features of the input request;
a model predictor that applies one or more machine learning (ML) based prediction models to the one or more local features and the one or more mapped global features of the input request to compute a fraud score for the input request;
a fraud detector that uses the fraud score for the input request to determine whether the input request for service subscription is to be accepted.

13. by a training dataset comprising a plurality of training instances, wherein each training The system of claim 12, wherein the one or more ML based prediction models are trained instance in the plurality of training instances comprises one or more training local features and one or more mapped training global features of a training input request and a training label, wherein the one or more training local features of the training input request are of same feature types as the one or more local features of the input request, wherein the one or more mapped training global features are mapped from one or more training global features of a population of training input requests via the one or more mapping functions, and wherein the one or more training global features are of same feature types as the one or more global features.

14. The system of claim 12, wherein the one or more ML based prediction models include one or more of: artificial neural networks, multi-layer perceptron, convolutional neural networks, deep neural networks, feedforward neural networks, recurrent neural networks, models based on boosting frameworks, models based on AdaBoost, models based on gradient boosting, regression analysis models, linear regression models, non-linear regression models, support vector machines, decision trees, or Gaussian process regression models.

15. The system of claim 12, wherein the one or more ML based prediction models include a ML based prediction model to be re-trained based on one or more of: a model re-training time schedule, a drop in prediction accuracy, inclusions of one or more input-request originating applications in one or more fraudulent application lists, inclusions of one or more input-request originating applications in one or more app stores, or changes in distributions of the one or more global features.

16. The system of claim 12, wherein the fraud detector is configured to perform:
determining whether the fraud score for the input request is below a minimum fraudulent score threshold;
in response to determining that the fraud score for the input request is below the minimum fraudulent score threshold, determining that the input request is not fraudulent.

17. The system of claim 12, wherein the at least one of the one or more client-device-originated messages representing the input request confirms a subscription of a user operating the client device to one or more cloud-based media content services.

18. The system of claim 12, further comprising:
filtering out suspicious input requests, among all received input requests, based on a rule-based system;
performing request aggregation with respect to the input request based on a unique identifier that uniquely identifies a user operating the client device, wherein the unique identifier represents one or more of: client device properties, browser properties, web view properties, or a mobile station international subscriber directory number (MSISDN).

19. The system of claim 12, wherein the input request is determined to be non-fraudulent by a rule based system applying a set of fraud detection rules to the input request.

20. The system of claim 19, wherein the set of fraud detection rules are generated based on one or more of: heuristics, expert knowledges, user input, UI interactive states, or Wireless Application Service Providers' Association (WASPA) blocking lists.

21. The system of claim 12, wherein the one or more messages includes one or more of: HTML messages, XML messages, SOAP messages, JSON messages, AJAX messages, or RESTful messages.

22. The system of claim 12, wherein the one or more messages are originated from the client device by way of one or more of: web views or applications running on the client device.
